(19) United States
(12) Patent Application Publication
(10) Pub. No.: US 2006/0146455 A1
(43) Pub. Date: Jul. 6, 2006

(54) GFCI protective device

(76) Inventor: David V. Keller, Jackson, TN (US)

Correspondence Address: THE BLACK & DECKER CORPORATION, 701 EAST JOPPA ROAD, TW199, TOWSON, MD, 21286, US

(21) Appl. No.: 11/022,322

(22) Filed: Dec. 22, 2004

Related U.S. Application Data
(60) Provisional application No. 60/531,730, filed on Dec. 22, 2003.

(51) Int. Cl. H02H 3/00

(52) U.S. Cl. 361/42

(57) ABSTRACT

A protective device for use with a GFCI or electrical plug includes at least one flange for holding the GFCI or plug off of a surface (e.g., a ground or floor surface) during use. The protective device may be permanently affixed to the GFCI housing, the cord, or the electrical plug, or may be made removable allowing the electrical cord to be more easily coiled and stored.

### CROSS-REFERENCE TO RELATED APPLICATIONS

The present application claims the benefit under 35 U.S.C. § 119(e) of U.S. Provisional Application Ser. No. 60/531,730, which is herein incorporated by reference in its entirety.

### FIELD OF THE INVENTION

The present invention generally relates to devices employing ground fault circuit interrupter (GFCI) devices and/or power cord electrical plugs, and more particularly to a protective device suitable for use with a GFCI or electrical plug for holding the GFCI or plug off of a surface (e.g., a ground or floor surface) during use.

### BACKGROUND

When power tools, particularly hand-held power tools are used in wet environments it is often desirable to employ an inline or electrical cord mounted ground fault circuit interrupter (GFCI). The GFCI constantly monitors electricity flowing in the circuit providing electricity to the power tool to sense any loss of current due to a ground fault. If the current flowing through the circuit differs by a small amount from that returning, the GFCI quickly interrupts the circuit (i.e., the GFCI switches off power to the circuit), and thus shuts off power to the power tool.

The electrical cord further includes an electrical plug which is often is plugged into an extension cord, particularly when the work area is distant from an electrical outlet or generator. When the power cord is dragged trough water, mud, or the like, the GFCI and/or electrical plug may become undesirably wet or muddy. Consequently, it would be desirable to provide a protective device for holding the GFCI or plug off of a surface, such as a ground or floor surface, which may be wet or muddy.

### SUMMARY OF THE INVENTION

The present invention to a protective device suitable for use with a GFCI or electrical plug for holding the GFCI or plug off of a surface (e.g., a ground or floor surface) during use. In exemplary embodiments, the protective device comprises a flange, which holds the housing or plug above the surface for preventing contact between the housing and the surface. The protective device may be permanently affixed to the GFCI housing, the cord, or the electrical plug, or may be made removable allowing the electrical cord to be more easily coiled and stored.

It is to be understood that both the forgoing general description and the following detailed description are exemplary and explanatory and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view illustrating a power tool employing a ground fault circuit interrupter (GFCI) protective device in accordance with an exemplary embodiment of the present invention;

FIG. 2 is an exploded isometric view illustrating the ground fault circuit interrupter (GFCI) protective device shown in FIG. 1; and

FIG. 3 is an isometric view illustrating protective device for an electrical plug in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

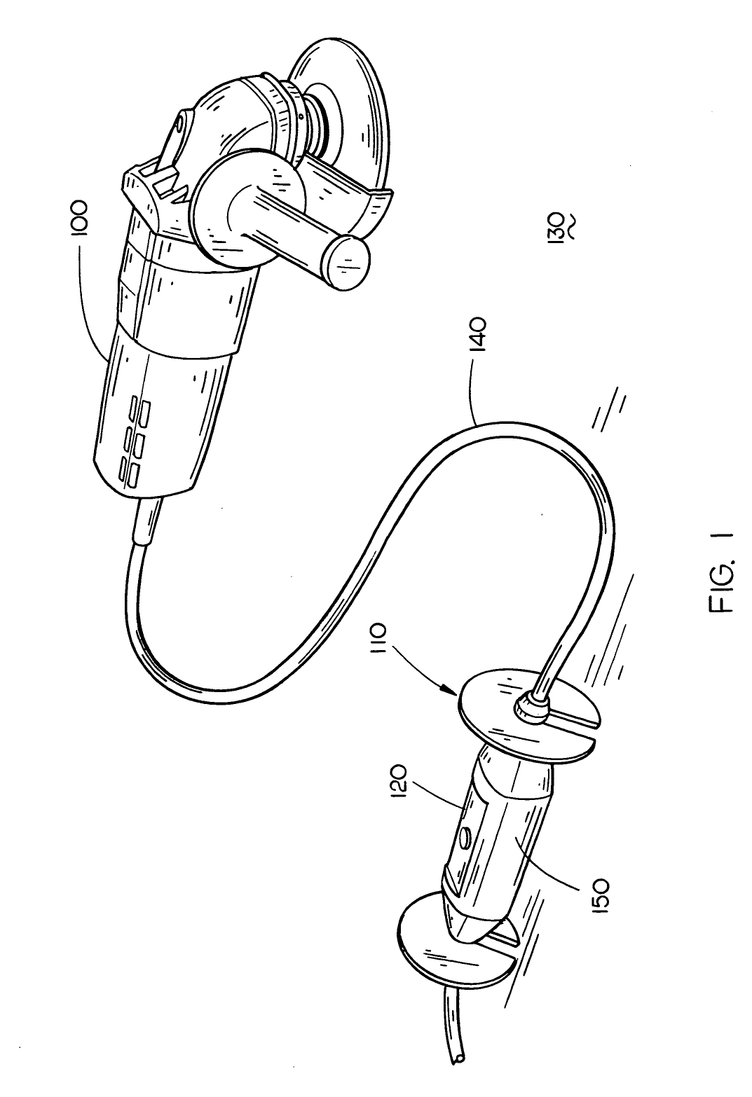

FIG. 1 illustrates a power tool 100 employing a protective device 110 in accordance with an exemplary embodiment of the present invention employed with an in-line ground fault circuit interrupter (GFCI) 120. The protective device 110 is attached to GFCI 120 to support the GFCI 120 above a surface 130 such as a floor or ground surface. In this manner, the GFCI 120 is prevented from being placed in water, mud, snow, or the like. The protective device 110 may also help to prevent water from running down the cord set 140 and entering GFCI 120 during operation of the power tool 100 in wet environments. Preferably, the protective device 110 allows the cord set 140 to which it is attached to be pulled across the surface 130 and remain above the surface 130 on which the GFCI 120 would otherwise rest, which may be wet, preventing potential contamination of the GFCI 120 and malfunction of the power tool 100.

In the exemplary embodiment illustrated, the GFCI 120 comprises a housing 150 attached along the cord set 140 coupled to the power tool 100, which is electrically powered. FIG. 1 illustrates the GFCI protective device 110 used with a Wet Polisher (specifically a Flex LW1503 Wet Polisher). However, it will be appreciated that the protective device 110 may be employed with any electrically powered device including but not limited to stationary tools such as table saws, contractor saws, and the like; hand tools such as hand drills, circular saws, reciprocating saws, wet polishers, grinders, sanders, and the like; consumer electronic equipment (e.g., portable stereos, work lights, etc.), audio equipment, and video equipment. Moreover, the protective device 110 shown in FIG. 1 is shown in an embodiment adapted for use with an inline GFCI. However, it is contemplated that the protective device 100 may also be used with GFCI devices provided as part of an extension cord terminated at one end with a male electrical plug and at the other end with one or more female electrical plugs, or by stand-alone GFCI devices (i.e., GFCI devices which are separate from a cord set 140), or the like, without departing from the scope and intent of the present invention.

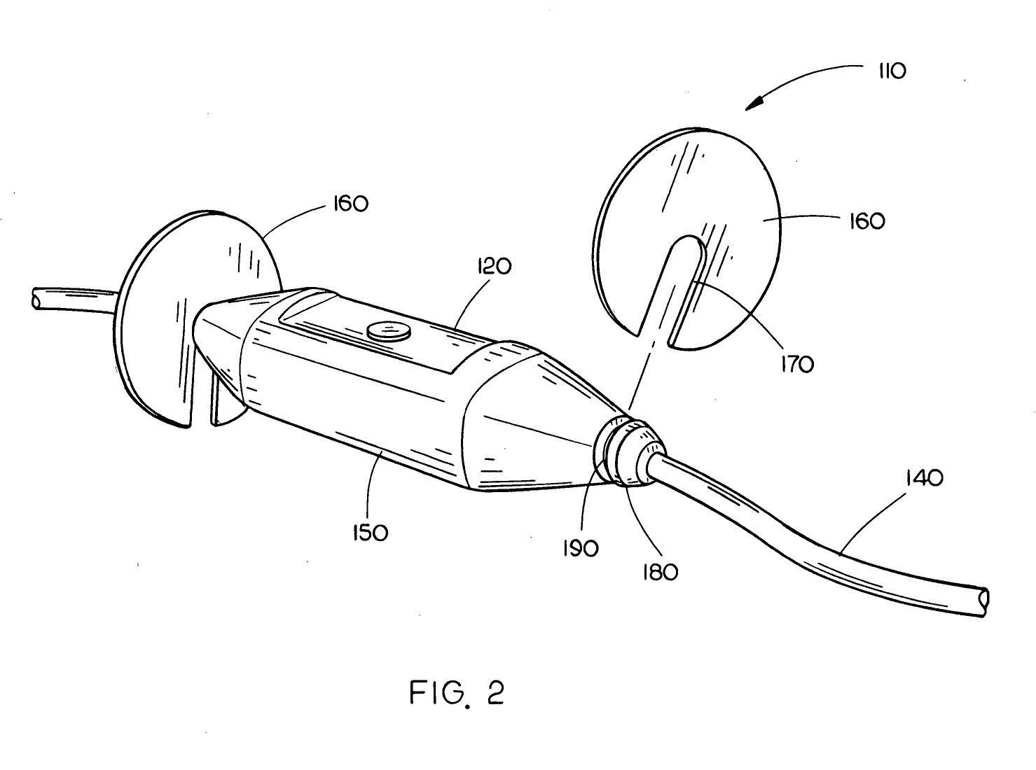

As shown in FIG. 2, the protective device 110 comprises one or more flanges (two flanges are shown) 160 that support the GFCI housing 150 above the surface 130. It will be appreciated that the flanges 160 may be permanently attached to the GFCI housing 150, or may be removable to facilitate storage of the cord set. For example, as illustrated, the flanges 160 fit over the ends of the GFCI housing 150. In the particular embodiment shown, the flanges 160 include a slot 170 which slides over the ends of the GFCI housing 150. The housing 150 includes a tapered first end having a first flange mounting member 180 for receiving a first one of the flanges 160 and a second end having a second flange mounting member 180 for receiving a second one of the flanges 160. Preferably, each flange mounting member 160 is rounded and may include a groove or channel 190 which is inserted into the flange slot 170 when the flange 160 is received onto the flange mounting member 180.

In the embodiment shown in FIGS. 1 and 2, the flanges 160 illustrated are flattened and generally circular or disk shaped. However, it will be appreciated that the flanges 160 are not necessarily limited to this shape but may alternatively be formed in other shapes (e.g., oval, rectangular, square, cross-shaped, pentagonal, hexagonal, octagonal, ball-shaped, or the like). Moreover, in the embodiment illustrated in FIGS. 1 and 2, the protective device 110 comprises two flanges 160. However, it is contemplated that in exemplary embodiments of the invention only one flange 160 may be provided, or alternatively, three or more flanges 160 may be provided without departing from the scope and intent of the present invention.

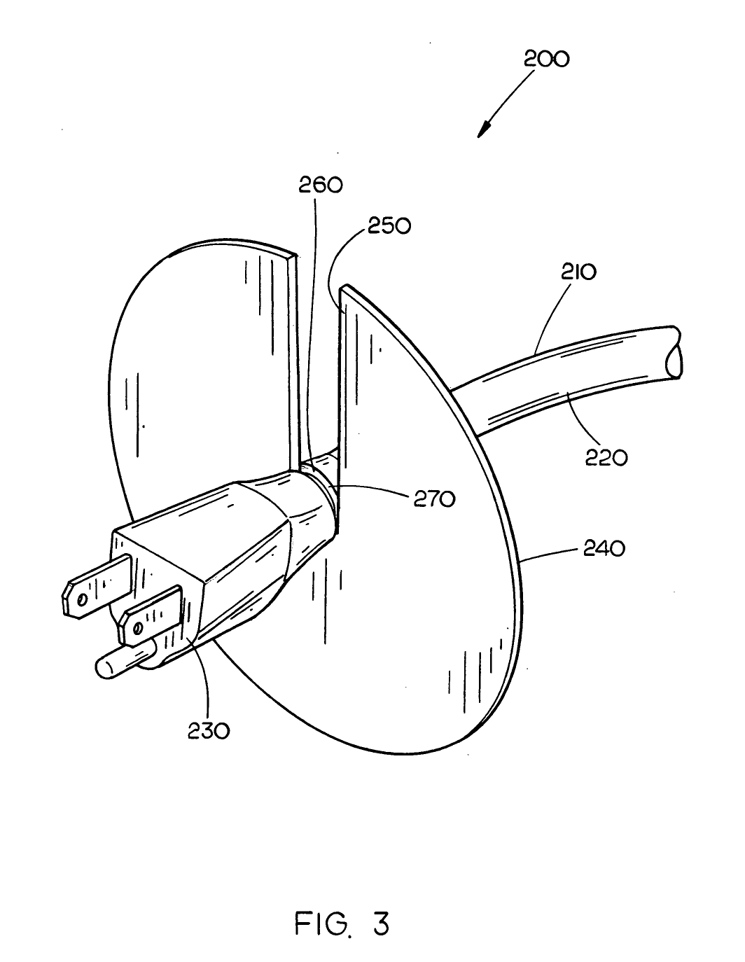

Turning now to FIG. 3, a protective device 200 for a power cord 210 having an electrical cord 220 and an electrical plug 230 is described in accordance with an exemplary embodiment of the present invention. The protective device 200 is attached to the electrical plug 230, or alternatively, the electrical cord 220 of the power cord 210 to support the plug 230 above a surface such as a floor or ground surface. In this manner, the electrical plug 230 is prevented from being placed in water, mud, snow, or the like. The protective device 200 may also help to prevent water from running down the electrical cord 220 in wet environments. Preferably, the protective device 200 allows the electrical plug 230 to which it is attached to be pulled across the surface when plugged to the female plug of an extension power cord, and to remain above the surface on which the electrical plug 230 would otherwise rest.

As shown in FIG. 3, the protective device 200 comprises a flange 240 coupled to one of the electrical plug 230 and the electrical cord 210. The flange 240 may be permanently attached to the plug 230 or cord 210, or may be removable to facilitate coiling and storage of the power cord 210. For example, like the embodiment shown in FIGS. 1 and 2, the flange 240 includes a slot 250 which slides over the end of the end of the electrical plug 230 adjacent to the electrical cord 220. The electrical plug 230 includes a flange mounting member 260 for receiving the flange 240. In the specific embodiment shown, the flange mounting member 260 is rounded and includes a groove or channel 270 which is inserted into the flange slot 250 when the flange 240 is received onto the flange mounting member 260.

In the embodiment shown in FIG. 3, the flanges 240 illustrated is flattened and generally circular or disk shaped. However, as in the embodiment shown in FIGS. 1 and 2, it will be appreciated that the flange 240 is not necessarily limited to this shape but may alternatively be formed in other shapes (e.g., oval, rectangular, square, cross-shaped, pentagonal, hexagonal, octagonal, ball-shaped, or the like) without departing from the scope and intent of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A ground fault circuit interrupter device, comprising:
a ground fault circuit interrupter for interrupting a circuit upon sensing a loss of current in the circuit;
a housing for housing the ground fault circuit interrupter; and
a protective device coupled to the housing for supporting the housing above a surface to prevent contact between the housing and the surface.

2. The ground fault circuit interrupter device as claimed in claim 1, wherein the protective device comprises a flange.

3. The ground fault circuit interrupter device as claimed in claim 2, wherein the flange is permanently coupled to the housing.

4. The ground fault circuit interrupter device as claimed in claim 2, wherein the flange is removable from the housing.

5. The ground fault circuit interrupter device as claimed in claim 4, wherein the housing comprises a flange mounting member for receiving the flange.

6. The ground fault circuit interrupter device as claimed in claim 5, wherein flange mounting member comprises a circumferential groove formed therein and the flange includes a radial slot extending from the center of the flange to an edge of the flange for engaging the groove to secure the flange to the flange mounting member.

7. The ground fault circuit interrupter device as claimed in claim 1, wherein the protective device comprises a first flange and a second flange and the housing comprises a first end having a first flange mounting member for receiving the first flange and a second end having a second flange mounting member for receiving the second flange.

8. A power cord, comprising:
a electrical cord;
an electrical plug coupled to the electrical cord; and
a protective device coupled to the one of the electrical cord and the electrical plug for supporting the electrical plug above a surface to prevent contact between the electrical plug and the surface.

9. The power cord as claimed in claim 8, wherein the protective device comprises a flange.

10. The power cord as claimed in claim 9, wherein the flange is permanently coupled to the one of the electrical cord and the electrical plug.

11. The power cord as claimed in claim 9, wherein the flange is removable from the one of the electrical cord and the electrical plug.

12. The power cord as claimed in claim 11, wherein the one of the electrical cord and the electrical plug comprises a flange mounting member for receiving the flange.

13. The power cord as claimed in claim 12, wherein flange mounting member comprises a circumferential groove formed therein and the flange includes a radial slot extending from the center of the flange to an edge of the flange for engaging the groove to secure the flange to the flange mounting member.

14. A power tool, comprising:
an electrical cord;
a ground fault circuit interrupter coupled to the electrical cord for interrupting a circuit upon sensing a loss of current in the circuit;
a housing for housing the ground fault circuit interrupter;
a protective device coupled to the housing,
wherein the protective device is coupled to the housing for supporting the housing above a surface for preventing contact between the housing and the surface.

15. The power tool as claimed in claim 14, wherein the protective device comprises a generally disk shaped flange.

16. The power tool as claimed in claim 14, wherein the flange is permanently coupled to the housing.

17. The power tool as claimed in claim 14, wherein the flange is removable from the housing.

18. The power tool as claimed in claim 17, wherein the housing comprises a flange mounting member for receiving the flange.

19. The power tool as claimed in claim 18, wherein flange mounting member comprises a circumferential groove formed therein and the flange includes a radial slot extending from the center of the flange to an edge of the flange for engaging the groove to secure the flange to the flange mounting member.

20. The power tool as claimed in claim 14, wherein the protective device comprises a first flange and a second flange and the housing comprises a first end having a first flange mounting member for receiving the first flange and a second end having a second flange mounting member for receiving the second flange.
